(19) United States
(12) Patent Application Publication
(10) Pub. No.: US 2014/0290508 A1
(43) Pub. Date: Oct. 2, 2014

(54) IN-LINE INTEGRATED RAISED PRINTING

(71) Applicants: Itzik Shaul, Tel Avivi (IL); George Trendafilov, Tel Avivi (IL); Gilad Greenberg, Tel Avivi (IL); Gregory Doyle Creager, Boise, ID (US); Shaun Henry, Boise, ID (US)

(72) Inventors: Itzik Shaul, Tel Avivi (IL); George Trendafilov, Tel Avivi (IL); Gilad Greenberg, Tel Avivi (IL); Gregory Doyle Creager, Boise, ID (US); Shaun Henry, Boise, ID (US)

(21) Appl. No.: 14/355,126

(22) PCT Filed: Mar. 1, 2012
(86) PCT No.: PCT/US12/27300

§ 371 Date: Apr. 29, 2014

Related U.S. Application Data
(63) Continuation-in-part of application No. PCT/US11/58557, filed on Oct. 31, 2011.

(51) Int. Cl. B41M 1/24

(52) U.S. Cl. CPC B41M 1/24
USPC 101/32; 101/3.1

(57) ABSTRACT

A method for in-line integrated raised printing. The method includes performing a plurality of separations, and generating an embossing effect based on the performing said plurality of separations, wherein the embossing effect comprises a three-dimensional effect.

### RELATED APPLICATIONS

This Application claims priority to PCT/US2011/058557 filed on Oct. 31, 2011.

### BACKGROUND

Thermographic or raised printing utilizes post-process techniques. Typically, thermographic printing is performed by removing a print medium from a printer and utilizing off-line processes to generate the raised printing. The off-line processes can include additional equipment and specialized methods such as thermal processing that includes specialized powder. Accordingly, the off-line processes to generate the raised printing increases the time and cost for generating the raised printing.

### BRIEF DESCRIPTION OF THE DRAWINGS

FIGS. 1A-C, 3 and 4 illustrate examples of raised printing.

FIGS. 2 and 5 illustrate examples of a method for in-line integrated raised printing.

The drawings referred to in this description should be understood as not being drawn to scale except if specifically noted.

### DETAILED DESCRIPTION

Reference will now be made in detail to examples of the present technology, examples of which are illustrated in the accompanying drawings. While the technology will be described in conjunction with various examples, it will be understood that they are not intended to limit the present technology to these examples. On the contrary, the present technology is intended to cover alternatives, modifications and equivalents, which may be included within the spirit and scope of the various examples as defined by the appended claims.

Furthermore, in the following description of examples, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present examples.

It should be understood that the foregoing print engine description is provided by way of example, and that print blankets described herein are suitable for use with a variety of liquid toner print engines.

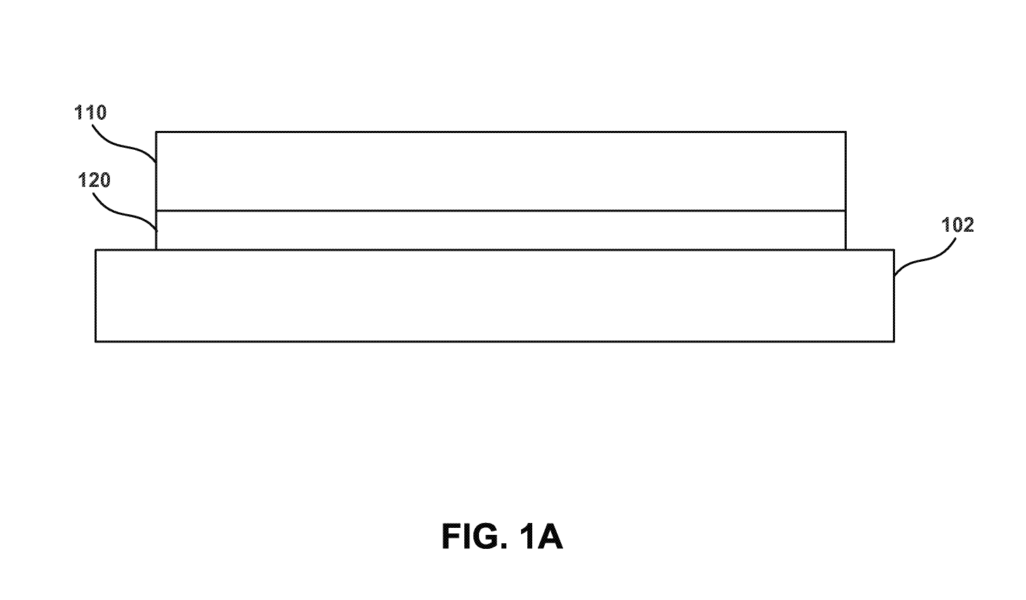

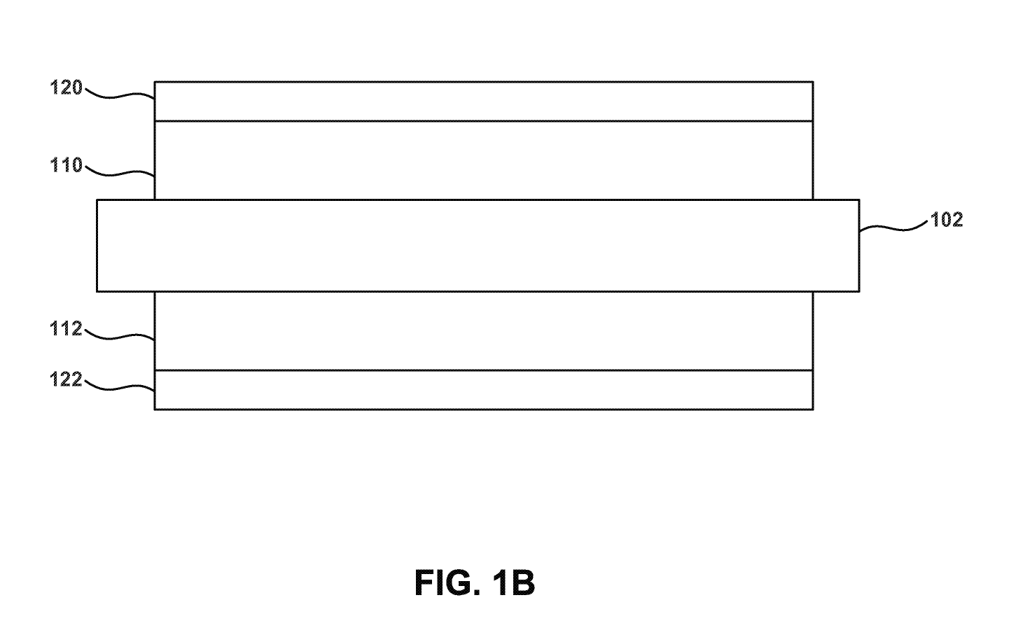

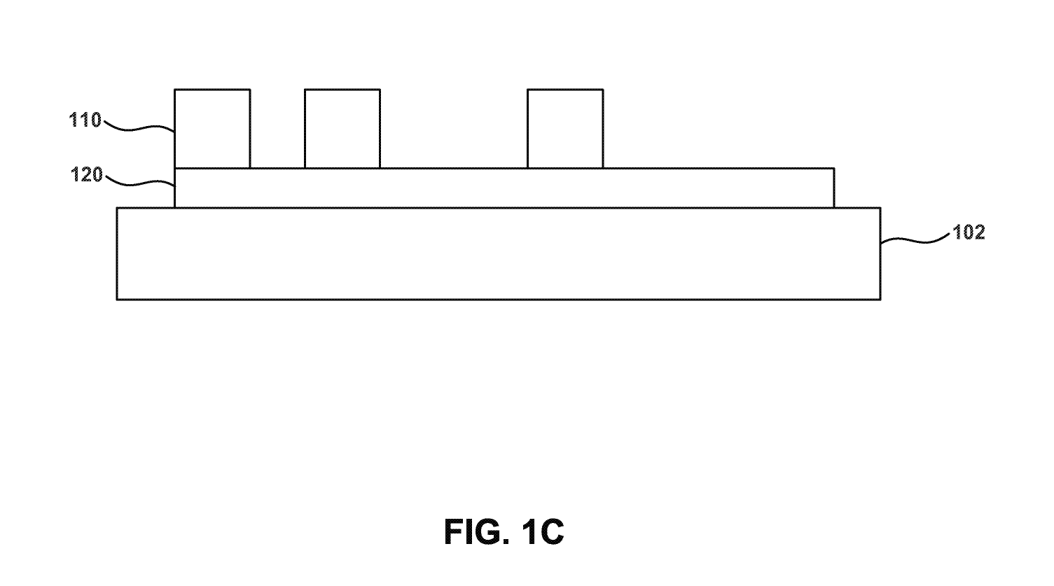

FIGS. 1A-C depicts a side view of examples of raised print that is created by a printer (not shown). It should be appreciated that the printer can generate an image on print medium 102.

The printer is able to create a “raised print.” In general, a raised print involves raising a surface of ink above the image level (e.g., above the surface of the print medium) or generating an appearance that the surface of the ink is above the image level to create a textural and/or visual effect, such as an embossing effect. In general, an embossing effect, as used herein, pertains to any three-dimensional or tactile feel effect that is printed on a medium.

The printer generates a raised print by a plurality of linked printing processes solely by the printer. That means that the printer creates a raised print without requiring off-line printing activities. Accordingly, no special press set-up or off-line activities are required in order to create a raised print.

In contrast, conventional raised printing methods require that the raised printing be generated by off-line processes. For example, conventional raised print may be created by a thermal process using special powder via several off-line stations, plate pressure, post-printing manual embossing, etc.

In particular, the printer creates the raised printing by performing a plurality of separations in series without reinsertion of print medium 102. In various examples, the raised printing is accomplished by adjusting the process parameters (e.g., pressure, temperature, voltage, etc.) with respect to a print engine. It should be appreciated that the printer can be any printer that is able to performing a plurality of separations in series without reinsertion of print medium 102.

FIG. 1A depicts print medium 102, raised print 110 and image 120. In this example, image 120 is a CMYK image that is printed onto print medium 102 by a “regular” printing process, as described in detail above. CMYK refers to the four inks used in color printing: cyan, magenta, yellow, and black.

To create the raised print effect, raised print 110 is printed above image 120. Raised print 110 can be, but is not limited to, a transparent ink (e.g., matte ink), varnish, etc.

Raised print 110 can be generated by a plurality of printed separations. In other words, a plurality of layers and print repetitions creates raised print 110.

The number of repetition/layers can be defined by the user in order to achieve a desirable quality. For instance, the user can decide to print, in one example, from 1 up to 64 layers or more for a desired quality.

FIG. 1B depicts raised print 110 printed directly onto print medium 102 by raised print methods and image 120 is printed on top of raised print 110 by regular print methods. In one example, raised print 110 is opaque ink (e.g., white ink).

FIG. 18 also depicts duplex printing of a raised print. For example, raised print 112 is printed on the opposite side of print medium 102 than raised print 110. Also, image 122 is printed on top of raised print 112.

FIG. 1C depicts image 120 printed onto print medium 102. Raised print 110 is selectively printed onto image 120. In this example, raised print is a spot color or a basic color formed as a raised area. It should be understood that raised print 110 can be selectively disposed in any pattern that is compatible with creating a raised print effect.

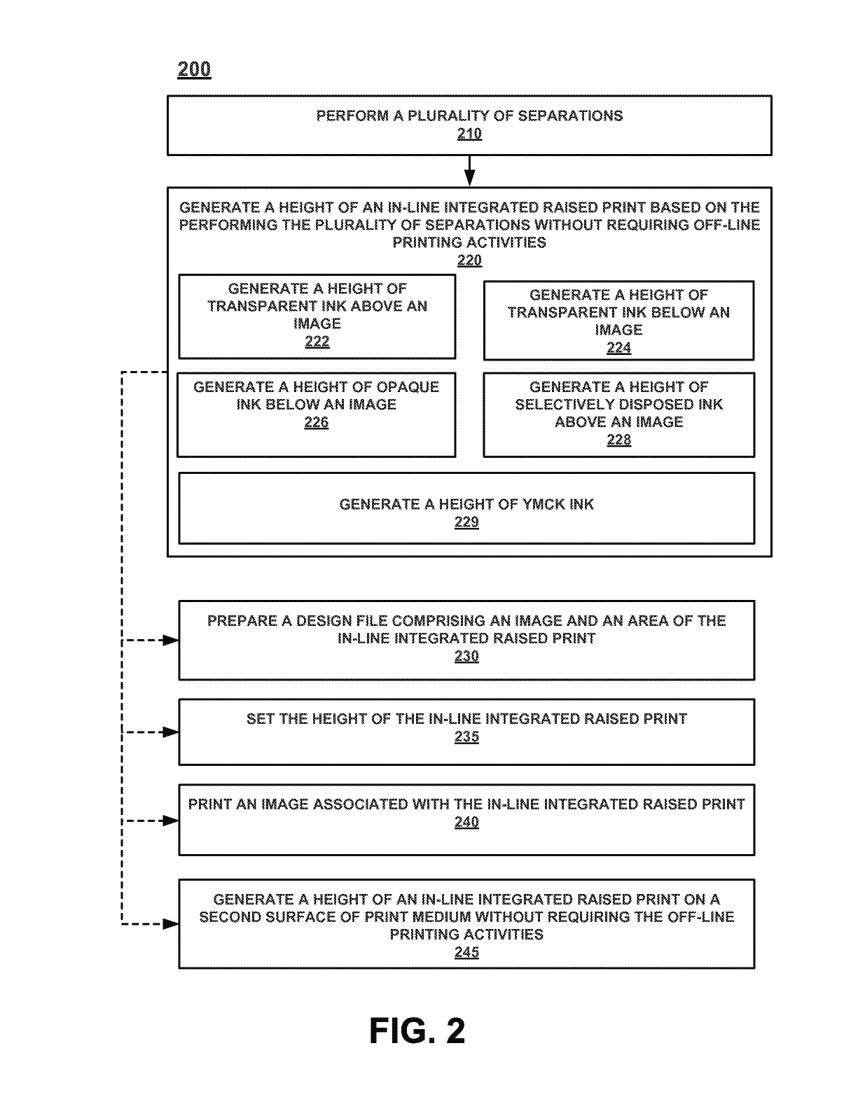

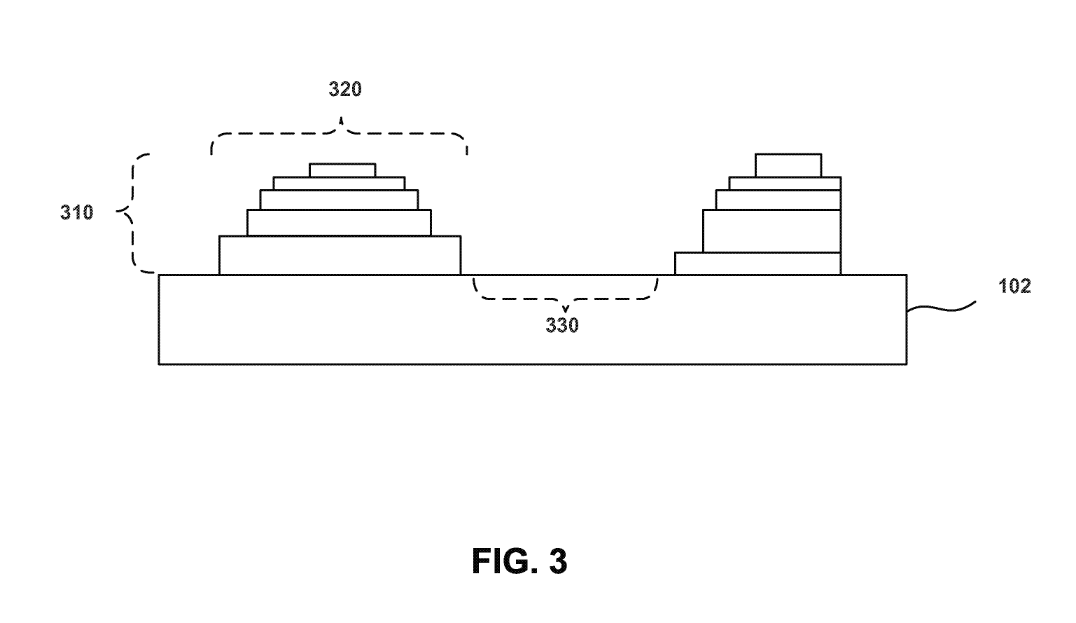

FIG. 2 depicts an example of method 200 for in-line integrated raised printing. In various examples, method 200 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some examples, method 200 is performed at least by a printer, as described above.

At 210 of method 200, a plurality of separations are performed. For example, a plurality of separations are performed by printer a printer to generate raised print 110. In other words, for example, at 220, a height of an in-line integrated raised print is generated based on the performing the plurality of separations without requiring off-line printing activities. For example, a height of in-line integrated raised print 110 is created based on the plurality of separations performed. In particular, the height of in-line integrated raised print 110 is generated without requiring off-line printing activities such as using off-line thermal processes.

In one example, the height of raised print 110 is determined by user input. For example, if a user requests that 50 layers are performed, and each layer is 1 μm, then the raised print will have a height of 50 μm.

In one example, at 222, a height of transparent ink is generated above an image. For example, with reference to FIG. 1A, raised print 110 (e.g., transparent ink) is disposed on top of image 120.

In one example, at 224, a height of transparent ink is generated below an image. For example, with reference to FIG. 1B, raised print 110 (e.g., transparent ink) is disposed below of image 120. In another example, at 226, a height of opaque ink is generated below an image. For example, raised print 110 (e.g., opaque white ink) is generated below image 120.

In a further example, at 228, height of selectively disposed ink is generated above an image. For example, with reference to FIG. 1C, raised print 110 (e.g., selectively disposed ink) is generated above image 120. In another example, at 229, a height of raised print 110 (e.g., CMYK ink) is generated above image 120.

At 230, a design file comprising an image and an area of the in-line integrated raised print is prepared. For example, a user generates a design file that includes image 120 and an area of in-line integrated raised print 110. It is should be understood that the preparation of the design file is performed before the in-line integrated raised printing is generated.

At 235, a height of the in-line integrated raised print is set. For example, a height of 50 microns is set at the height of the in-line integrated raised print 110. It should be appreciated that the height is indicative of the number of layers or separations that will need to be printed.

At 240, an image associated with the in-line integrated raised print is printed. For example, image 120 is printed by regular methods by a printer and is associated with raised print 110.

At 245, a height of an in-line integrated raised print is generated on a second surface of print medium without requiring the off-line printing activities. For example, with reference to FIG. 18, a duplex of raised print is generated. In such an example, raised print 112 is printed on an opposite side of print medium 102 than raised print 110.

The raised printing, as described herein, can be utilized to generate an embossing effect. Accordingly, no special set-up, or post printing processes are required, such as, molds, dies, etc.

FIG. 3 depicts an example of an embossing effect, for example, generated by a printer. The embossing effect is created by a plurality of separations 310 that are disposed on print medium 102. The embossment separations can be any separation of existing process colors (e.g., CMYK) or can be a separate separation. The color of an embossment separation can be any of the process colors or a spot or custom color. Additionally, the embossment separation can be a transparent or translucent color or lacquer. There may also be more than one embossment separation for a print job.

The embossing effect, as depicted, includes five separate separations. However, any number of separations may be generated to create an embossing effect.

Separations 310 may be comprised of opaque ink or may be non-opaque ink, such as, but not limited, to transparent or translucent varnish, lacquer, etc.

Additionally, separations 310 may include varying thicknesses. For example, the thickness of the separations may decrease in the direction of bottom (adjacent the print media) to top or in the direction of top to bottom. However, separations 310 can include any combination of varying thicknesses.

It should be appreciated that the printer adjusts its printing process to vary the thickness of the separations. For example, the printing engine adjusts its process to vary the thickness.

In one example, the embossing effect is a convex embossing effect. As such, there is a build-up of separations associated with a printed artifact or glyph.

For example, a letter “L” may include a convex embossing effect. In such an example, separations 320 are generated over the region of the letter “L.” In particular, there is a greater build-up of separations towards the center of the letter “L” than then periphery of the letter “L.” As such, separations 320 create a convex embossing effect for the letter “L.”

In another example, the embossing effect is a concave embossing effect. As such, there is a build-up of separations associated with a printed artifact or glyph.

For example, separations 310 are generated proximate an outline of a glyph or character. The region of the glyph or character is depicted as region 330. In such an example, the end portions or edges of separations 310 are disposed proximate region 330. In particular, there is a build-up of separations towards the outline or region 330 and no (or fewer) separations in region 330. As such, the build-up of separations 310 (around region 330) creates a concave embossing effect associated with region 330.

FIG. 4 depicts an example of an embossing effect. In such an example, concave and/or convex embossing effects are generated by separations 410. For example, a concave embossing effect is generated by laying down layers of ink (e.g., separations) over the entire (or substantially the entire) surface of print medium 102. As a result, the concave embossing effect is generated by building up (from bottom to top) the layers of ink.

In one example, a flat-surface embossing effect can be generated. For example, as depicted in FIG. 1A, raised print 110 (e.g., a plurality of separations) is disposed over image 120 to create a flat-surface embossing effect associated with image 120.

It should be appreciated that a print job creator indicates that the glyph or region of text (or of an image) is to be printed having an embossing effect (e.g., a concave embossing effect). The indication is defined via meta-data in the print job. The creator may also define embossing effect (e.g., color, height of embossment, spherical properties of embossment, etc.) This information allows a raster image processor (RIP) to generate the dynamic embossment separations. In general, a RIP produces a raster image also known as a bitmap. The bitmap is then sent to a printing device (e.g., printer 100) for output.

The RIP receives the print job page description language (PDL), such as, but not limited to, PS, PDF, EPS, XPS and determines which objects need to have embossment applied. The RIP then generates multiple embossment separations which, when laid down, one on top of another will create the desired embossing effect.

The RIP utilizes geometric calculations to determine the proper the proper pixel data that should be present in each of the dynamically generated embossment separations. The RIP also determines how many times each embossment separation should be printed in order to produce the correct shape of the embossing effect. This information is then stored along with the rasterized image data as meta-data.

In another example, the storing of the data is directed towards creating a new pixel format which, in addition to storing color and transparency information about the pixel, the pixel data-structure also stores information about the three-dimensional treatment that should be applied to the pixel. For example, a thickness or height of each pixel is defined for the embossment effect

In a separation based data storage technique, the thickness of each separation is defined for the embossment effect. For example, a CMYK job with a single, transparent separation could be described as, CMYK-E24. In such an example, the E24 indicates that the embossment separation should be laid down 24 times. The embossment separation may be a standard process color (e.g., magenta), thereby, yielding a color separation description such as CM-24YK.

There may be more than one embossment separation description, such as C-45MYK-50. In such an example, the cyan separation would be re-printed 45 times while the black separation would be re-printed 50 times.

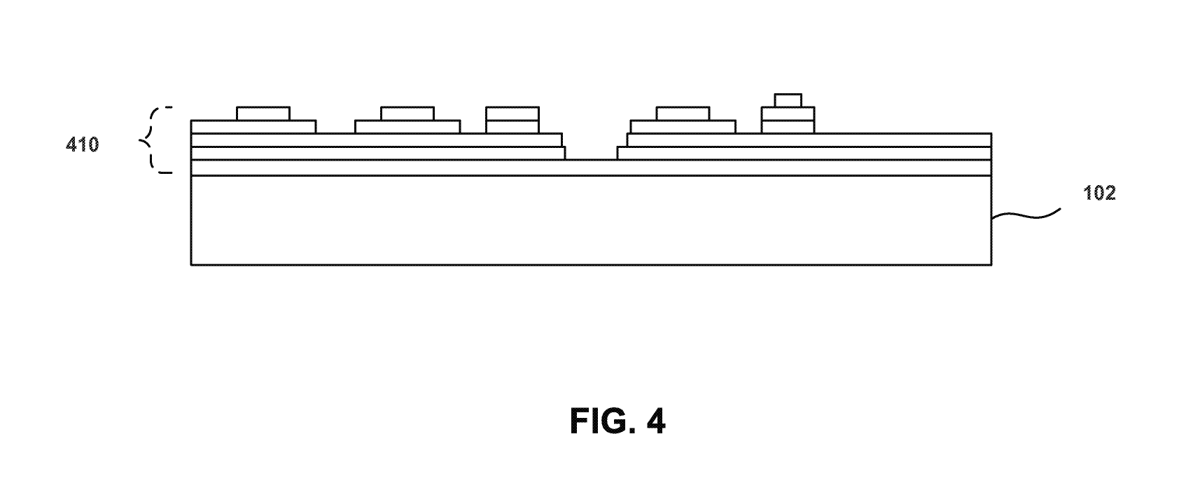

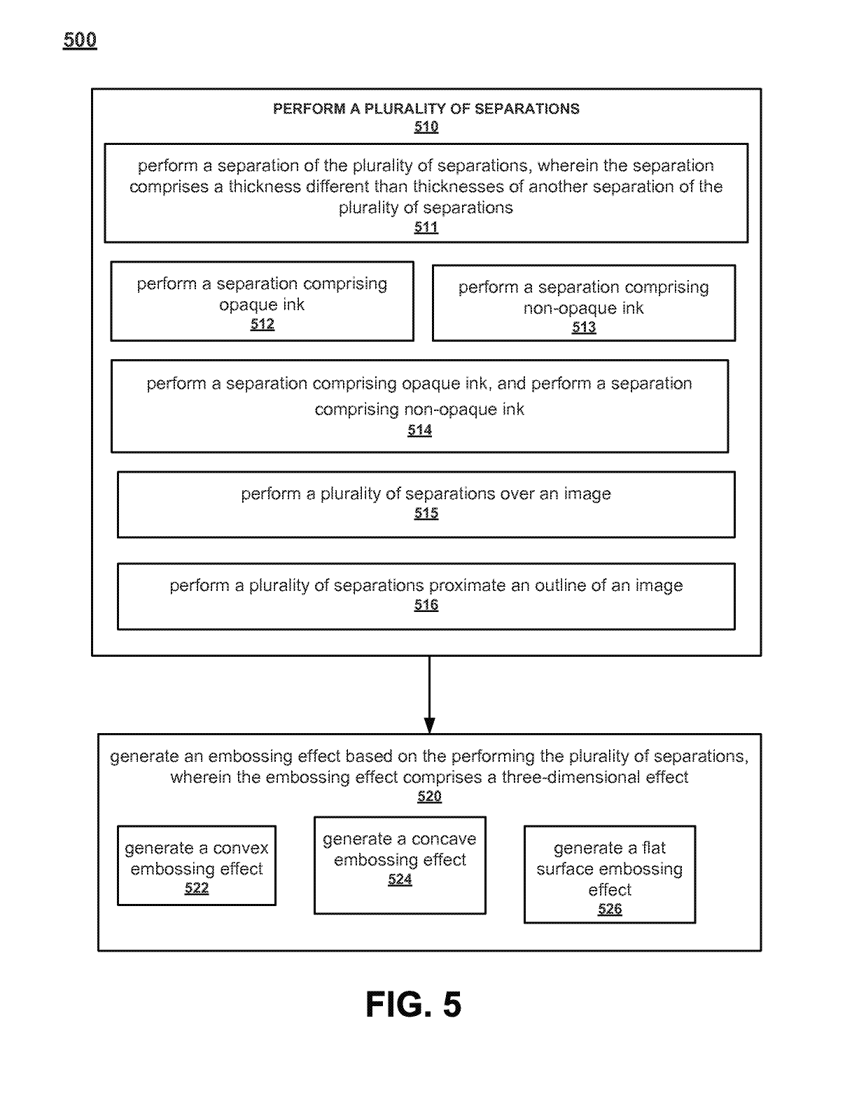

FIG. 5 depicts an example of method 500 for in-line integrated raised printing. In various examples, method 500 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some examples, method 500 is performed at least by a printer, as described above.

At 510 of method 500, a plurality of separations are performed. For example, a printer prints separations 310 onto print media 102.

At 511, a separation of the plurality of separations is performed. The separation comprises a thickness different than thicknesses of another separation of the plurality of separations. For example, a thickness of one separation is different than a thickness of another separation. In another example, a top separation that is waterproof or water-resistant is performed over all o the other previous separations, wherein the top separation has a thickness greater than the previous separations.

At 512, a separation is performed, wherein the separation comprises opaque ink. For example, at least one of separations 310 comprises opaque ink. At 513, a separation is performed, wherein the separation comprises non-opaque ink. For example, at least one of the separations 310 comprises a transparent or translucent lacquer.

At 514, a separation is performed of opaque ink and a separation is performed of non-opaque ink. For example, a transparent separation is performed on top or below a separation of an opaque ink.

At 515, a plurality of separations are performed over an image. For example, a transparent separations (e.g., separations 320) are performed over an image to create a convex embossing effect.

At 516, a plurality of separations are performed proximate an outline of an image. For example, the edges of separations 310 are disposed proximate region 330 to generate a concave embossing effect associated with region 330.

At 520, an embossing effect is generated based on the performing the plurality of separations wherein the embossing effect comprises a three-dimensional effect. For example, a printer prints separations 410 to generate an embossing effect.

At 522, a convex embossing effect is generated. For example, separations 320 are generated over the region of the letter “L.” Accordingly, a convex embossing effect is generated because there is a greater build-up of separations towards the center of the letter “L” than then periphery of the letter “L.”

At 524, a concave embossing effect is generated. For example, separations 310 are generated proximate an outline of a glyph or character to create the concave embossing effect.

At 526, a flat surface embossing effect is generated. For example, raised print 110 (e.g., a plurality of separations) is disposed over image 120 to create a flat-surface embossing effect associated with image 120.

Various examples of the present technology are thus described. While the present technology has been described in particular examples, it should be appreciated that the present technology should not be construed as limited by such examples, but rather construed according to the following claims. Moreover, examples, as described herein, can be utilized in combination with one another.

1. A method for in-line integrated raised printing, said method comprising:
performing a plurality of separations; and
generating an embossing effect based on said performing said plurality of separations, wherein said embossing effect comprises a three-dimensional effect.

2. The method of claim 1, wherein said performing a plurality of separations further comprises:
performing a separation of said plurality of separations, wherein said separation comprises a thickness different than a thicknesses of another separation of said plurality of separations.

3. The method of claim 1, wherein said performing a plurality of separations further comprises:
performing a separation comprising opaque ink.

4. The method of claim 1, wherein said performing a plurality of separations further comprises:
performing a separation comprising non-opaque ink.

5. The method of claim 1, wherein said performing a plurality of separations further comprises:
performing a separation comprising opaque ink; and
performing a separation comprising non-opaque ink.

6. The method of claim 1, wherein said performing a plurality of separations further comprises:
performing a plurality of separations over an image.

7. The method of claim 1, wherein said performing a plurality of separations further comprises:
performing a plurality of separations proximate an outline of an image.

8. The method of claim 1, wherein said generating an embossing effect further comprises:
generating a convex embossing effect.

9. The method of claim 1, wherein said generating an embossing effect further comprises:
generating a concave embossing effect.

10. The method of claim 1, wherein said generating an embossing effect further comprises:
generating a flat surface embossing effect.

11. A printer comprising:
a print engine to perform a plurality of separations and to generate an embossing effect based on said performing said plurality of separations, wherein said embossing effect comprises a three-dimensional effect.
